(19) United States
(12) Patent Application Publication
(10) Pub. No.: US 2015/0128809 A1
(43) Pub. Date: May 14, 2015

(54) HOME BEER BREWING CARBOY

(71) Applicant: Northern Brewer LLC, Roseville, MN (US)

(72) Inventors: John Thomas Hansmann, Minneapolis, MN (US); Bruce J. Newman, Bryn Mawr, PA (US)

(21) Appl. No.: 14/075,025

(22) Filed: Nov. 8, 2013

(51) Int. Cl. C12C 13/10; B65D 51/14; B65D 1/02

(52) U.S. Cl. CPC C12C 13/10; B65D 1/0207; B65D 1/0246; B65D 1/0284; B65D 51/145
USPC 99/276; 215/44; 215/276

(57) ABSTRACT

For fermentation of wort during home beer brewing, a food grade plastic or glass cylindrical bottle is used which includes materials to reduce or eliminate UV light transmission through the bottle, and to minimize oxygen ingress into the bottle during fermentation where the bottle includes a flared neck gradually widening in circumference when approaching a bottle opening surrounded by a rim and the opening has dimensions capable of allowing a hand and arm inside the bottle for cleaning

### FIELD OF THE INVENTION

The present invention relates generally to a system and method of a home beer brewing process, and more specifically to a carboy and system for use with home beer brewing.

### BACKGROUND

Conventional beer making methods, especially for the home brewing market, require the purchase of specific beer making equipment and supplies which can include: a kettle and an adjacent burner kit; chillers, fermentor, carboy or other container; bottling bucket, and cleaners, sanitizers, brushes and other cleaning equipment; tubing for siphoning and bottling; beer bottles, caps and a bottle capper; malted barley or extracts or other cereal grains; hops, yeast and other accessories and ingredients dependent on the specific beer recipe.

The brewing process includes the steps of making wort by soaking grains in water to release malt sugars—alternatively previously made dry or liquid extract can be used, boiling the wort and water together with the hops and cooling the wort after boiling; and fermenting the cooled wort for a predetermined period of time in a primary fermentation process by adding yeast to the wort. A large bottle also known as a carboy with a relatively narrow neck and opening as shown in FIG. 1 is traditionally used in home brewing to produce beer from the wort due to the fermentation activities of yeast added to the wort within the carboy. Multiple carboys could be used for primary and secondary fermentation.

After the fermentation process is completed, the wort is transferred from the carboy to consumer drinking bottles that are capped. The carboy must be cleaned to remove the krausen ring that forms during fermentation as well as settled yeast and solids that settle out or adhere to the internal sides and bottom of the carboy. A typical method for cleaning the inside of a carboy involves using a specially designed brush which can penetrate all the way to the bottom of the bottle and can be bent or adjusted to clean the sides as well. Another cleaning method involves inserting a rag with cleaner and shaking vigorously. After the carboy is cleaned and sanitized it is generally inverted to drain the residual liquid in the carboy. Prior to the next use, the carboy is sanitized.

In some instances, a home brewer may have multiple carboys for brewing various beers and he/she may also have numerous extra carboys that require storage. Typical home beer brewing carboys are about 5 to 6.5 gallons each, so space requirements for storage and brewing can be a problem. Moreover transfer, movement and general handling of these relatively large carboys whether empty or filled with wort can present logistical problems.

There is a desire and a need for improvements in home beer brewing carboy systems especially for cleaning, brewing, drying and space considerations for brewing and storage of the carboys.

### BRIEF SUMMARY OF EMBODIMENTS

The above and other aspects of various embodiments of the present invention will become apparent in view of the following description, claims and drawing.

For fermentation of wort during home beer brewing, a food grade plastic or glass cylindrical bottle is used which includes: materials (1) to reduce or eliminate UV light transmission through the bottle; and (2) to minimize oxygen ingress into the bottle during fermentation. The bottle includes a flared neck gradually widening in circumference when approaching a bottle opening surrounded by a rim. The opening has dimensions capable of allowing a hand and arm inside the bottle for cleaning. The neck of the bottle includes: external screwing threads adjacent to the bottle opening; one or more flanges positioned along a body of the bottle for bottle handling; a punted or conical bottom for wort and yeast separation during home beer brewing; and volume markers positioned on a side of the bottle for volume measurement.

Additionally, the bottle has a two piece lid including a lid insert and a nylon ring. The circular food grade plastic or glass lid insert engages the bottle adjacent to and along the rim for covering an area corresponding to the opening and the rim. The nylon ring, which screws onto the external screwing threads of the bottle, includes a lip to be tightened against the lid insert along the rim onto the screwing threads. The lid insert includes one or more tapered cylindrical pipe sections to form bung holes whereby each pipe section is molded to protrude above a plane of the lid insert and each pipe section facilitates connection or insertion of home beer brewing hoses or bungs to the pipe section. Tightening of the nylon ring onto the external screwing threads along the flared neck provides a gasket-free water-tight seal.

A carboy system can also include a single-piece dryer/stacker having a lower circular support flange section and a circular upper support system. The lower circular support flange section is connected to an external cylindrical wall having one or more external wall openings to allow connection of the hoses onto the pipe sections of the lid insert and traversal of the hoses outside of the stacker during the home beer brewing process and to allow air movement through the one or more external wall openings and throughout the bottle opening when the lid insert is removed and the bottles are drying. The circular upper support system has protruding tower supports spaced apart and fixedly attached there between by support sections. The tower supports have top angled sections and a common cylindrical wall of the tower supports extends downwards within the dryer/stacker to a form a disk shaped ring having a circular opening. The circular upper support system snuggly fits and engages the bottle neck during bottle stacking During bottle storage, beer fermentation or bottle drying, the lower circular support flange section engages a bottom of a first bottle and the circular upper support system engages a second bottle to stack the first and second bottle in a circumferential footprint of one bottle.

### BRIEF DESCRIPTION OF THE DRAWING

FIG. 1 is a side view of a conventional home beer brewing carboy;

FIG. 2 is a side view of a home beer brewing carboy system in accordance with the invention;

FIG. 3A is an expanded side perspective view of components of the carboy system of FIG. 2;

FIG. 3B is a side cross-sectional view of the lid insert of FIG. 3A;

FIG. 3C is a top view of the lid insert of FIGS. 3A and 3B;

FIG. 4A is a top perspective view of a carboy dryer/stacker in accordance with the invention;

FIG. 4B is a bottom perspective view of a carboy dryer/stacker in accordance with the invention;

FIG. 5 is a side view of two bottles stacked on top of one another using a carboy dryer/stacker in accordance with the invention; and

FIG. 6 is a partial side cutout view of two bottles stacked on top of one another using the carboy dryer/stacker in accordance with the invention.

### DETAILED DESCRIPTION

In the following description, specific details are set forth although it should be appreciated by one of ordinary skill that the systems and methods can be practiced without at least some of the details. In some instances, known features or processes are not described in detail so as not to obscure the present invention.

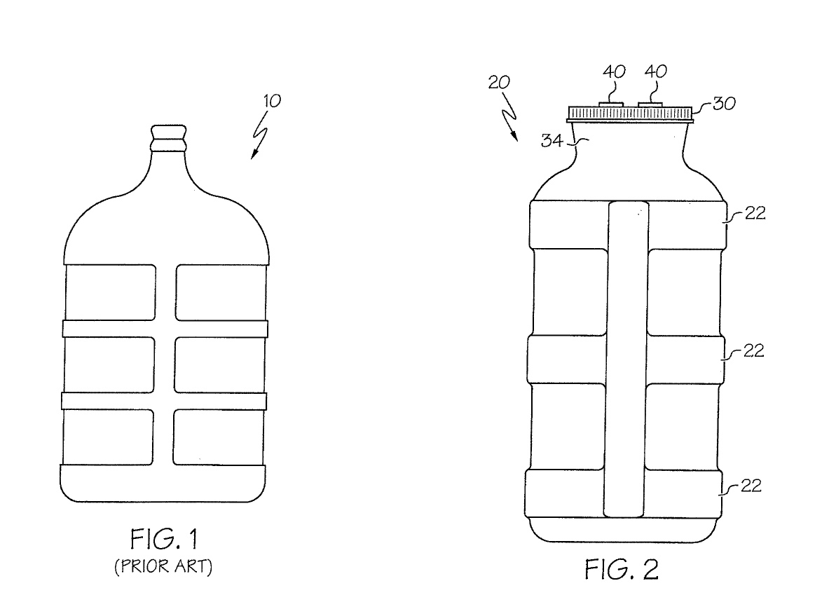

FIG. 2 is a side view of a home brewing carboy system according to the present invention. The carboy system includes a cylindrical bottle 20 of food grade glass or plastic preferably having one or more ribs or flanges 22 which can add strength to the cylindrical wall of the bottle 20 and also provide gripping leverage while handling the bottle 20. Although the carboy bottles can be any size and volume, the most common bottle sizes are in the order of 5 to 6.5 gallons. The bottles can have a punted bottom or a conical bottom (not shown) to aid in wort and yeast separation and wort transport that results in improved clarity of fermented beverages. The bottles are similar in size and shape to conventional bubbler drinking water bottles.

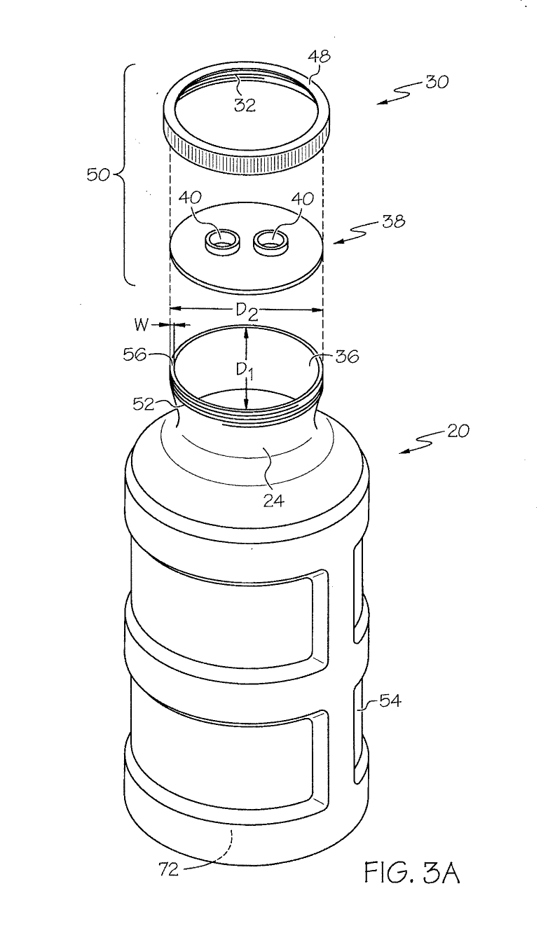

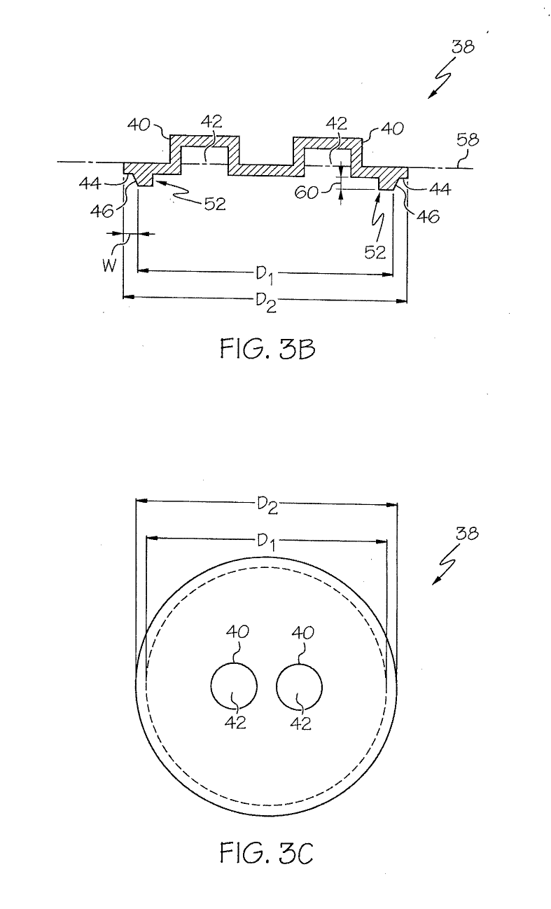

FIG. 3A shows an expanded side perspective view of components of the carboy system 20 of FIG. 2. The carboy bottle 20 includes a wide upper section neck 24 having a rim 56 along an opening 36, the neck 24 being flared out to gradually widen in circumference when approaching the opening 36. When a lid is screwed and tightened onto the flared neck, the seal becomes water-tight thus removing the need for gaskets and washers and also obviating bacterial trapping.

The flared bottle neck includes external screwing threads 52 molded onto the external neck bottle surface surrounding the opening 36 which is large enough to allow a hand and a portion of an arm inside the bottle for cleaning The diameter D₁ of the opening 36 can vary so long as a person's hand and arm is able to reach into the bottle for cleaning. An exemplary opening diameter D₁ is about 14.0 centimeters or 5½ inches. Also the diameter of the bottle body 54 and the diameter of the neck 24 can be the same in one embodiment.

The carboy system 20 includes a two piece lid 50 having a circular lid insert 38 and a ring 30. FIG. 3B shows a side cross-sectional view of the lid insert 38 of FIG. 3A, and FIG. 3C shows a top view of the lid insert 38 of FIGS. 3A and 3B. The bottle 20 and lid insert 38 of the carboy system 20 may be in contact with beer wort and thus are made from food grade glass or plastic such as high-density polyethylene (HDPE), polyethylene terephthalate (PET) or the like.

PET was chosen as the preferred plastic material to minimize oxygen ingress into the bottle during. Additives have been included in the PET carboy to reduce or eliminate UV light transmission through the bottle. This helps to maintain the integrity of the beer, Glass does not allow oxygen to penetrate the through minimize oxygen ingress into the bottle during fermentation

The lid insert 38 portion of the lid 50 is a circular component as viewed from the top (see FIG. 3C) having a diameter D₂ and having one or more bung holes 42 within molded cylindrical HDPE tapered pipe sections 40 that protrude above a plane 58 of the lid insert 38. Each pipe section 40 facilitates the connection or insertion of hoses or bungs (not shown) to the pipe section 40 for use in a home beer brewing process.

FIG. 3B shows a side cross-sectional view of the circular lid insert 38 of FIG. 3A having an outer diameter D₂, a surface plane 58, pipe sections 40 with bung holes 42, and a lower circular indent section 52 having a diameter Di as shown. The indent section 52 is molded as part of the lid insert 38. It recesses a distance 60 below a lower surface of the lid insert and it is offset a distance W along a lower surface section 44 (of the lid insert 38). The indent section 52 also includes a tapered surface 46 for firmly settling and engaging the lid insert into the opening 36 of the bottle so that the lower surface section 44 contacts and is adjacent with the rim 56 surrounding the opening 36. The tapered surface 46 will engage and be adjacent to an inner wall (not shown) of the bottle having a diameter Di so that the indent section 52 acts as a washer to seal the contents of the bottle when the lid 50 is completely tightened and sealed. The width W of the rim ideally equals the width W of the lower section 44 of the lid insert 38 although some variation is allowable, and the inner bottle diameter D₁ ideally equals the indent section 52 diameter D₁. In one embodiment an additional washer can be used between the lid insert 38 and the bottle rim 56 as an additional seal of the lid 50 onto the bottle.

The nylon ring 30 portion of the lid 50 is structured with a protruding lip 48 that matches to a contour of the top edge or rim 56 of the bottle at the bottle opening. In order to secure the lid 50 onto the bottle, first the lid insert 38 is placed onto the opening 36 so that the lower section 44 of the lid insert 38 lines up and engages to the rim 56. Then the nylon ring 30 is placed over the lid insert 38, turned and tightened so that the internal threads 32 of the ring 30 engage with the bottle threads 52, whereby the top edge or protruding lip 48 of the ring 30 is drawn tight against the lid insert 38 to secure the lid 50 onto the bottle as shown in FIG. 2.

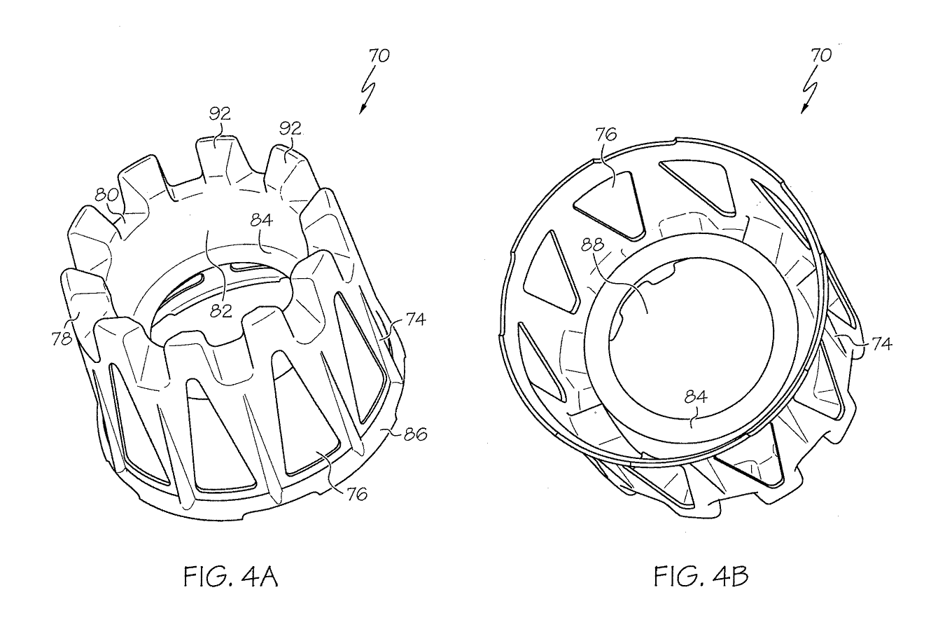

The carboy dryer/stacker 70 is illustrated in FIGS. 4A, 4B, 5 and 6. FIG. 4A is a top perspective view and FIG. 4B is a bottom perspective view of a carboy dryer/stacker 70 in accordance with the invention. The carboy dryer/stacker 70 includes a lower circular support ring or flange section 86 connected to an external cylindrical wall with vertically extending external wall supports 74 having one or more wall openings 76. The external wall supports 74 extend upward from the lower circular support ring or flange 86 to a circular solid upper support system having protruding tower supports 78 spaced apart and fixedly attached there between by sections 80, the tower supports including top angled sections 92. A common inner cylindrical wall 82 of the tower supports 78 extends downwards within the dryer/stacker 70 to a form a disk shaped ring 84 having a circular opening 88. The diameter of the lower circular support ring 86 is larger than the diameter of the inner cylindrical wall 82 which in turn is larger than the diameter of the circular opening 88.

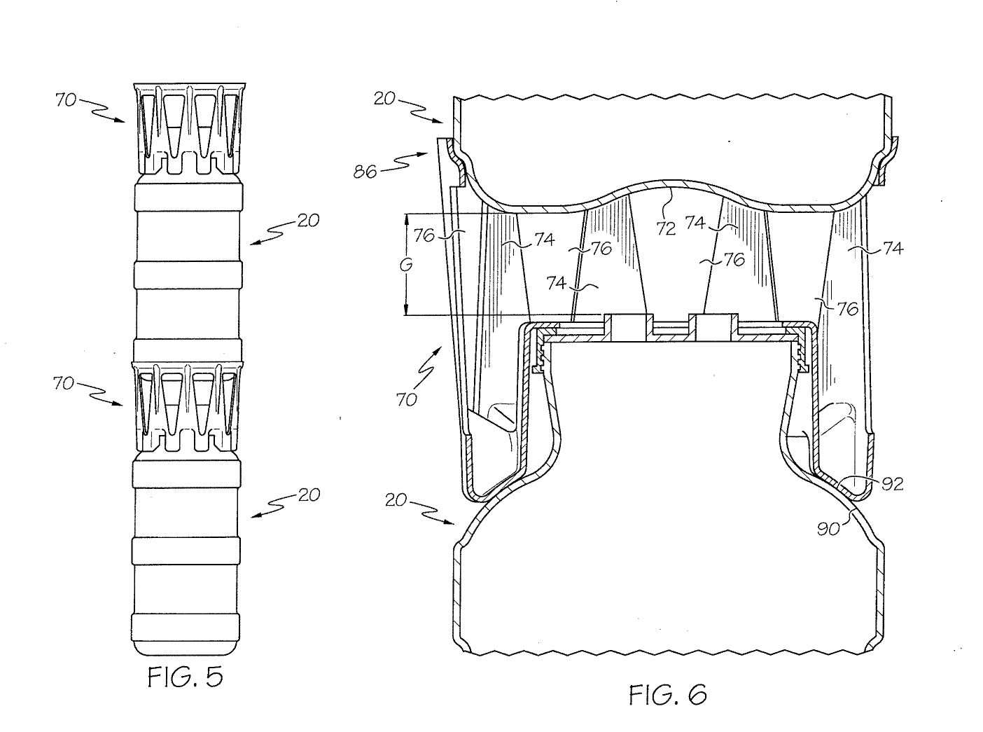

The lower circular support ring or flange 86 flares outwards and gradually becoming wider as shown in the figures in order to accommodate and fit snugly together with a bottom 72 of a bottle 20 when bottles are stacked one upon another as shown in FIGS. 5 and 6. When stacking bottles, the bottom 72 of one bottle 20 engages and snuggly fits with the lower circular support ring or flange section 86 of the carboy dryer/stacker 70. As illustrated in FIG. 6 a second bottle is stacked by placing the top of the second bottle, where the opening 36 or lid 50 is located, into the carboy dryer/stacker 70 so that the top of the bottle 20 or lid 50 sits on the disk shaped ring 84, the neck fits snuggly adjacent to the inner cylindrical wall 82, and the angular section 90 of the bottle fits snuggly adjacent to the top angled sections 92 of the tower supports 78.

As described above, multiple home beer brewing bottles 20 can be stacked on top of one another in a single footprint which is the circumference of the body of one bottle. FIG. 5 shows two bottles stacked on top of one another with the bottle openings on the bottom facing downwards and with a carboy dryer/stacker 70 on the bottom of the stack and located on a solid surface such as a floor. In this stacking position, the bottles can be empty with the lids removed so that the bottles can be drying out by allowing surrounding air to traverse in and out of the bottles via the one or more wall openings 76 of the carboy dryer/stackers 70.

Bottles can also be stacked for brewing as shown in FIG. 5. The bottles will be sealed and hoses or bungs as necessary will be used in conjunction with the bung holes to seal the bottles for fermentation and conditioning while allowing multiple carboys to be brewing in a singular footprint of the circumference of the body of one bottle. The hoses will extend through the one or more wall openings 76 of the carboy dryer/stackers 70 as needed for the home brewing process. In order to accommodate the connected hoses and bungs during brewing, a minimum gap G of 51.3 millimeters or 2.0 inches between the stacked bottles is necessary (see FIG. 6).

The carboy dryer/stacker 70 can stack bottles with either the lids 50 screwed onto the bottles, or with the lids removed for drying. Also, when bottles are not in use for brewing or drying, they can be stacked in a single bottle footprint using carboy dryer/stackers.

While the invention has been shown and described with reference to specific embodiments, it should be understood by those skilled in the art that various changes in form and detail may be made therein without departing from the spirit and scope of the invention.

What is claimed is:

1. A food grade plastic or glass cylindrical bottle for fermentation of wort during home beer brewing, the bottle comprising:
materials to reduce or eliminate UV light transmission through the bottle, and to minimize oxygen ingress into the bottle during fermentation;
a flared neck gradually widening in circumference when approaching a bottle opening surrounded by a rim, the opening having dimensions capable of allowing a hand and arm inside the bottle for cleaning, the neck comprising external screwing threads adjacent to the opening;
one or more flanges positioned along a body of the bottle for bottle handling;
a punted or conical bottom for wort and yeast separation during home beer brewing; and
volume markers positioned on a side of the bottle for volume measurement.

2. The food grade plastic or glass cylindrical bottle of claim 1 wherein the materials comprise polyethylene terephthalate PET, high density polyethylene HDPE and Nylon.

3. The food grade plastic or glass cylindrical bottle of claim 1 further including a two piece lid comprising: a circular food grade plastic or glass lid insert to engage the bottle adjacent to and along the rim for covering an area corresponding to the opening and the rim, and a nylon ring to screw onto the external screwing threads, the nylon ring comprising a lip to be tightened against the lid insert along the rim upon tightening of the nylon ring onto the screwing threads, the lid insert comprising one or more tapered cylindrical pipe sections to form bung holes, each pipe section molded to protrude above a plane of the lid insert, each pipe section facilitating connection or insertion of home beer brewing hoses or bungs to the pipe section, wherein tightening the nylon ring onto the external screwing threads along the flared neck provides a gasket-free water-tight seal.

4. The food grade plastic or glass cylindrical bottle of claim 1 wherein the bottle is a 5 gallon bottle or a 6.5 gallon bottle.

5. The food grade plastic or glass cylindrical bottle of claim 1 wherein the opening of the neck is about 14.0 centimeters in diameter.

6. A carboy system for use with home beer brewing, comprising:
a cylindrical bottle of food grade glass or plastic comprising one or more flanges positioned around a circumference of a bottle body for bottle handling, and a neck in an upper section of the bottle and an opening on one end of the neck capable of allowing a hand and arm inside the bottle for cleaning, the neck including a rim along the opening and external screwing threads adjacent to the opening, the neck flared to gradually widen in circumference when approaching the opening; and
a two piece lid having a circular food grade material lid insert to engage the bottle adjacent to and along the rim for covering an area corresponding to the opening and the rim, and a nylon ring to screw onto the external screwing threads, the nylon ring comprising a lip to be tightened against the lid insert along the rim upon tightening of the nylon ring onto the screwing threads, the lid insert comprising one or more tapered cylindrical pipe sections to form bung holes, each pipe section molded to protrude above a plane of the lid insert, each pipe section facilitating connection or insertion of home beer brewing hoses or bungs to the pipe section,
wherein tightening the nylon ring onto the external screwing threads along the flared neck provides a gasket-free water-tight seal.

7. The carboy system of claim 6 further comprising a single-piece dryer/stacker comprising:
a lower circular support flange section connected to an external cylindrical wall having one or more external wall openings to allow connection of the hoses onto the pipe sections of the lid insert and traversal of the hoses outside of the stacker during the home beer brewing process and to allow air movement through the one or more external wall openings and throughout the bottle opening when the lid insert is removed and the bottles are drying; and
a circular upper support system including protruding tower supports spaced apart and fixedly attached there between by support sections, the tower supports having top angled sections, a common cylindrical wall of the tower supports extending downwards within the dryer/stacker to a form a disk shaped ring having a circular opening, said circular upper support system snuggly fitting and engaging the bottle neck during bottle stacking;
wherein during bottle storage, beer fermentation or bottle drying, the lower circular support flange section engages a bottom of a first bottle and the circular upper support system engages a second bottle to stack the first and second bottle in a circumferential footprint of one bottle.

8. The carboy system of claim 6 wherein the single-piece dryer/stacker is frusto conically shaped or cylindrically shaped.

9. The carboy system of claim 6 wherein the cylindrical bottle is a 5 gallon bottle or a 6.5 gallon bottle.

10. The carboy system of claim 6 wherein the opening of the neck is about 14.0 centimeters in diameter.

11. The carboy system of claim 6 wherein the one or more bung holes allow brewing accessories to be inserted into wort or fermenting beer within the bottle during brewing.

12. The carboy system of claim 11 wherein the brewing accessories comprise thermocells, blow-off tubes, airlocks and temperature control units.

13. The carboy system of claim 6 further comprising a removable harness for securing a body and the neck of the bottle during maneuvering, moving and turning the bottle upside down, said harness comprising flexible straps engaged around the neck and body of the bottle and engaged with the one or more flanges.

14. The carboy system of claim 6 wherein the bottle further comprises materials to reduce or eliminate UV light transmission through the bottle, and to minimize oxygen ingress into the bottle during fermentation.

15. The carboy system of claim 6 wherein the lid insert comprises high density polyethylene HDPE material or polyethylene terephthalate PET material.

16. The carboy system of claim 6 wherein the lid insert comprises material to minimize oxygen ingress during fermentation and conditioning of wort within the bottle.

17. The carboy system of claim 6 wherein the bottle further comprises a punted or conical bottom.

18. The carboy system of claim 6 wherein the bottle body further comprises volume markers for home beer brewing.

19. The carboy system of claim 7 wherein a minimum gap of 2 inches is maintained between the stacked first and second bottles.
